(19) United States
(12) Patent Application Publication
(10) Pub. No.: US 2009/0000577 A1
(43) Pub. Date: Jan. 1, 2009

(54) Waste heat collecting apparatus

(75) Inventor: Masashi Miyagawa, Ichinomiya-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/214,524

(22) Filed: Jun. 19, 2008

(30) Foreign Application Priority Data
Jun. 27, 2007 (JP) 2007-169785

(51) Int. Cl. F01P 9/02; B60H 3/00; F28D 15/00

(52) U.S. Cl. 123/41.2; 165/42; 165/104.21

(57) ABSTRACT

A waste heat collecting apparatus includes a loop-type heat pipe and a valve device. The loop-type heat pipe includes a vaporizing portion, a condensing portion, and a connecting portion. The valve device includes a driving portion and a valve body. The driving portion is configured to be actuated in accordance with at least one of pressure of the first medium, temperature of the first medium, and temperature of the second medium. The valve body is formed integrally with the driving portion for opening and closing the connecting portion in association with the driving portion. The valve device is provided at one of (a) a position downstream of the condensing portion, and (b) a position upstream of the vaporizing portion.

### CROSS REFERENCE TO RELATED APPLICATION

This application is based on and incorporates herein by reference Japanese Patent Application No. 2007-169785 filed on Jun. 27, 2007.

This application relates to copending application Ser. No. 11/641,518 entitled “WASTE HEAT COLLECTING APPARATUS” filed on Dec. 19, 2006.

### BACKGROUND OF THE INVENTION

1. Field of the Invention

The present invention relates to a waste heat collecting apparatus, which collects waste heat of exhaust gas from an internal combustion engine by using a loop-type heat pipe. The waste heat collecting apparatus utilizes the collected heat for heating a heat medium, such as a engine coolant and engine oil of the internal combustion engine.

2. Description of Related Art

A heat exchanger of a heat pipe type is known in the art, for example, as disclosed in JP-A-4-45393. A conventional heat exchanger of this prior art has a loop-type heat pipe, wherein a flow control valve is provided in a condensed fluid passage that connects a condensing portion with a vaporizing portion for controlling an amount of working fluid (heat-transfer fluid) flowing through the condensed fluid passage.

In the above conventional heat exchanger, a bypass passage is provided, which is bifurcated from another passage (vapor flow passage) that connects the vaporizing portion with the condensing portion. A driving portion of the flow control valve is provided in the bypass passage, such that the driving portion is operated when vapor pressure in the vapor flow passage is (higher than a predetermined pressure). Also, there is provided a slave valve in the condensed fluid passage on a side of the flow control valve toward the condensing portion, and the slave valve closes the condensed fluid passage in association with the operation of the driving portion.

The driving portion is formed, for example, as a diaphragm motor, which is composed of a diaphragm having a valve body connected to the diaphragm. Further, the slave valve is formed, for example, as an emergency closing valve for closing the condensed fluid passage, which includes a link and a cable both moved in association with displacement of the diaphragm. A communication pipe is further provided between the diaphragm motor and the emergency closing valve such that the communication pipe discharges vapor, which has entered the diaphragm motor, to the emergency closing valve.

Accordingly, opening degree of the flow control valve is adjusted depending on temperature of the working fluid (heat-transfer fluid) in the condensing portion. As a result, an amount of heat transfer to the working fluid is adjusted, and an inner pressure of the heat pipe is controlled at a value, which is within a desired range.

In the case where the flow control valve is kept opened under any abnormal condition, and the vapor pressure exceeds a predetermined pressure as a result of excessive vaporization at the vaporizing portion, the driving portion is operated so that the condensed fluid passage is closed by the slave valve which is operated in association with the driving portion. Accordingly, the circulation of the working fluid is forcibly stopped to limit the vapor pressure from abnormally becoming higher than the predetermined pressure. A blowout of the heat pipe is thereby prevented, for example.

According to the above conventional heat exchanger, the driving portion is provided in the vapor flow passage, whereas the emergency closing valve is provided in the condensed fluid passage. Therefore, the system requires the link and wire for operatively associating both of them as above. Furthermore, the communicating pipe is required for discharging the vapor (which has entered the driving portion) to the emergency closing valve. As above, the structure of the heat exchanger is complicated as a whole.

In addition, when the operation for the heat pipe is stopped due to the closing of the emergency closing valve, the inner pressure of the heat pipe is decreased and thereby the emergency closing valve is opened again in a short period. An inter-rock means is, for example, necessary for the link and/or cable in order to avoid the above re-open of the emergency closing valve. This is also one of reasons why the structure of the heat exchanger becomes complicated.

### SUMMARY OF THE INVENTION

The present invention is made in view of the above disadvantages. Thus, it is an objective of the present invention to address at least one of the above disadvantages.

To achieve the objective of the present invention, there is provided a waste heat collecting apparatus, which includes a loop-type heat pipe and a valve device. The loop-type heat pipe includes a vaporizing portion, a condensing portion, and a connecting portion. The vaporizing portion is configured to vaporize a first medium in the vaporizing portion by using heat of exhaust gas from an internal combustion engine. The condensing portion is configured to cool down the vaporized first medium, which is vaporized in the vaporizing portion, by using a second medium. The connecting portion is configured to connect the vaporizing portion with the condensing portion. The valve device includes a driving portion and a valve body. The driving portion is configured to be actuated in accordance with at least one of pressure of the first medium, temperature of the first medium, and temperature of the second medium. The valve body is formed integrally with the driving portion for opening and closing the connecting portion in association with the driving portion. The valve device is provided at one of (a) a position downstream of the condensing portion, and (b) a position upstream of the vaporizing portion.

### BRIEF DESCRIPTION OF THE DRAWINGS

The invention, together with additional objectives, features and advantages thereof, will be best understood from the following description, the appended claims and the accompanying drawings in which:

FIG. 1 is a schematic view showing a waste heat collecting apparatus installed in a vehicle;

FIG. 2 is a cross sectional view showing a waste heat collecting apparatus according to a first embodiment of the present invention;

FIG. 3 is a cross sectional view taken along a line III-III in FIG. 2;

FIG. 4 is a cross sectional view showing a valve device for the first embodiment in a valve opened condition;

FIG. 5 is a cross sectional view showing the valve device for the first embodiment in a valve closed condition;

FIG. 6 is a diagram showing a relation of an inner pressure of a heat pipe and a temperature of engine coolant with respective to heat quantity of exhaust gas;

FIG. 7 is a diagram showing an operation of valve opening and closing for the valve body of the valve device;

FIG. 8A is a time chart showing a change of the inner pressure of the heat pipe after a start of an engine operation;

FIG. 8B is a time chart showing a change of the temperature of the engine coolant after the start of the engine operation;

FIG. 8C is a time chart showing a change of the heat quantity of the exhaust gas in relation to a loaded condition of the engine after the start of the engine operation;

FIG. 9 is a cross sectional view showing a valve device according to a second embodiment of the present invention;

FIG. 10 is a cross sectional view showing a valve device according to a third embodiment of the present invention;

FIG. 11 is a cross sectional view showing a waste heat collecting apparatus according to a fourth embodiment of the present invention;

FIG. 12 is a cross sectional view showing a waste heat collecting apparatus according to a fifth embodiment of the present invention;

FIG. 13 is a cross sectional view showing a waste heat collecting apparatus according to a modification of the fifth embodiment;

FIG. 14 is a cross sectional view showing a waste heat collecting apparatus according to a sixth embodiment of the present invention;

FIG. 15 is a cross sectional view showing a waste heat collecting apparatus according to a seventh embodiment of the present invention;

FIG. 16 is an enlarged view showing a reverse flow limiting portion of the seventh embodiment;

FIG. 17 is an enlarged view showing a modification of the reverse flow limiting portion;

FIG. 18 is an enlarged view showing a restricting portion;

FIG. 19 is a cross sectional view showing a waste heat collecting apparatus in an inclined position according to a comparison example;

FIG. 20 is a schematic view showing a waste heat collecting apparatus installed in an automotive vehicle according to an eighth embodiment of the present invention;

FIG. 21 is a schematic view showing a waste heat collecting apparatus installed in the automotive vehicle according to a modification of the eighth embodiment;

FIG. 22 is a schematic view showing a waste heat collecting apparatus installed in an automotive vehicle according to a ninth embodiment of the present invention; and

FIG. 23 is a schematic view showing a waste heat collecting apparatus installed in the automotive vehicle according to a modification of the ninth embodiment.

### DETAILED DESCRIPTION OF PREFERRED EMBODIMENTS

### First Embodiment

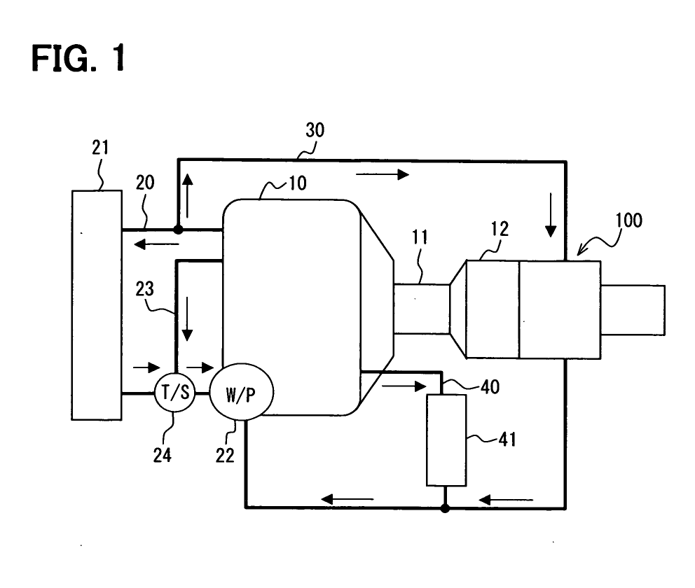

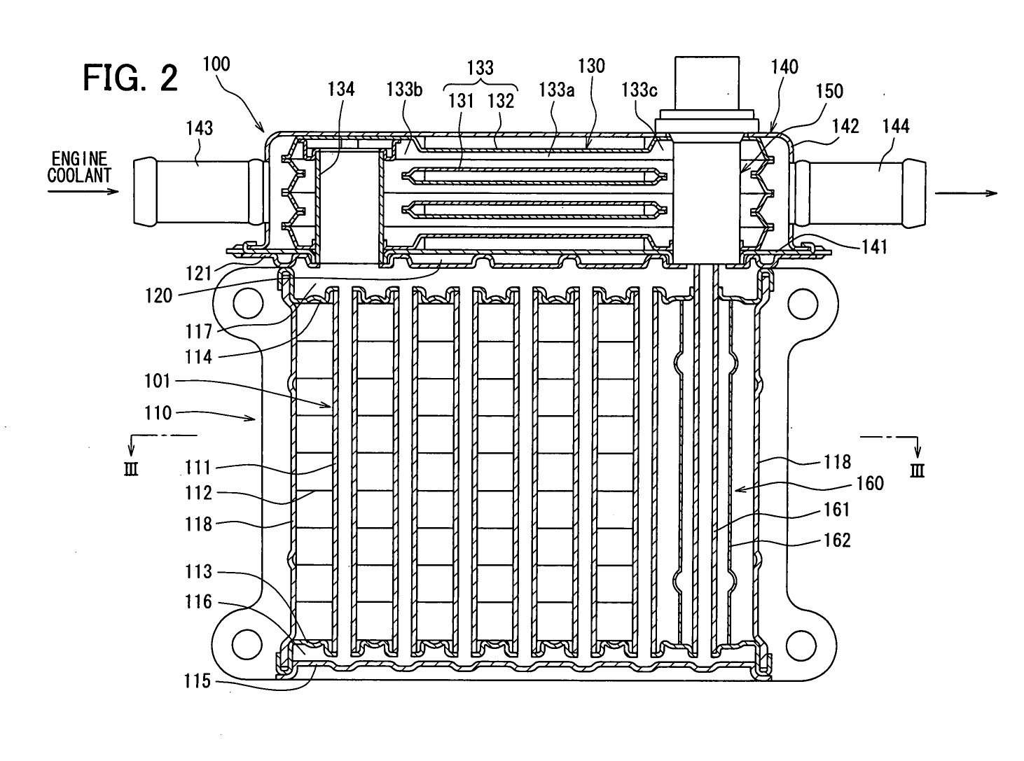

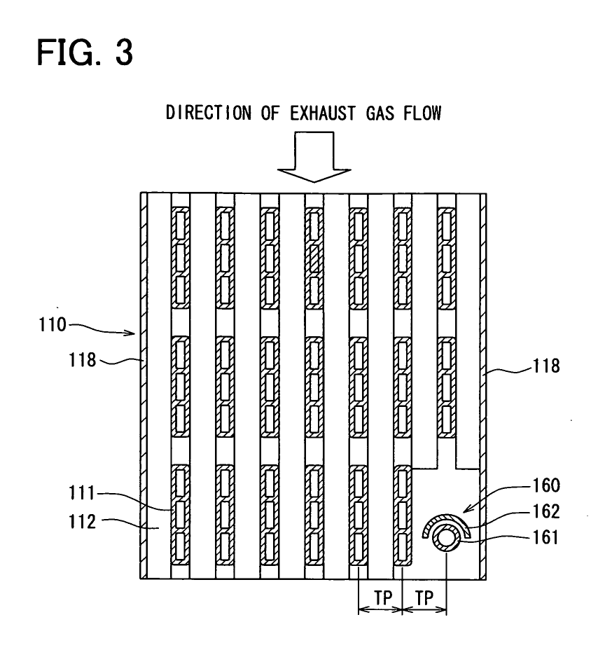

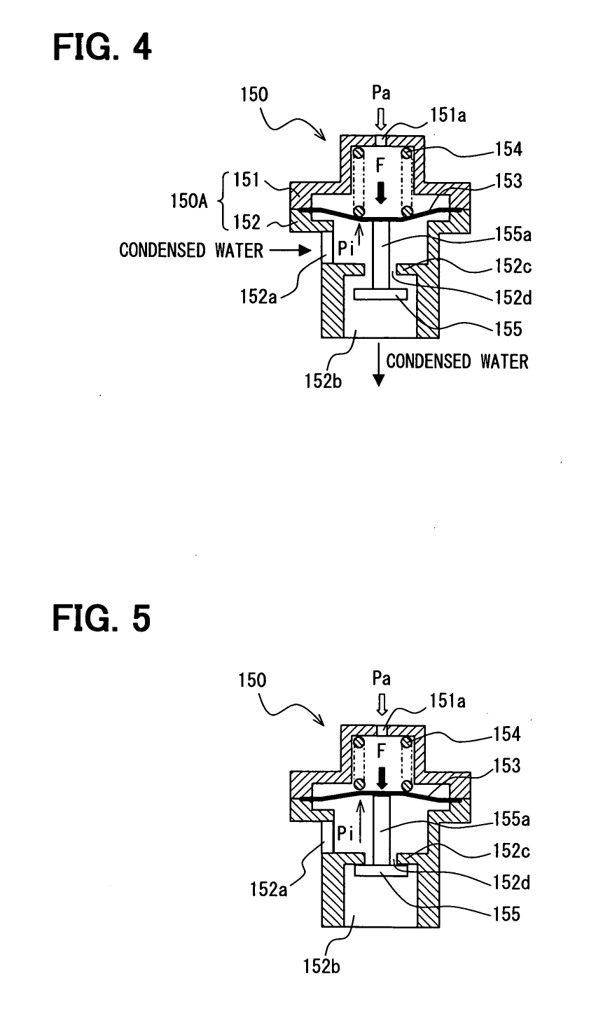

A waste heat collecting apparatus 100 according to a first embodiment of ; the present invention is applied to a vehicle having an engine 10 for producing a driving power for the vehicle. The waste heat collecting apparatus 100 is provided in an exhaust pipe 11 and a waste heat collecting circuit 30 of the engine 10. More detailed structure will be explained with reference to FIGS. 1 to 5. FIG. 1 is a schematic view showing the waste heat collecting apparatus 100 installed in the vehicle. FIG. 2 is a cross sectional view of the waste heat collecting apparatus 100. FIG. 3 is a cross sectional view taken along a line Ill-Ill in FIG. 2. FIG. 4 is a cross sectional view showing a valve device 150 provided in the waste heat collecting apparatus 100 in a valve opened condition, and FIG. 5 is a cross sectional view showing the valve device 150 in a valve closed condition.

As shown in FIG. 1, the engine 10 is a water cooled type internal combustion engine, and has the exhaust pipe 11 for emitting exhaust gas which is produced after combustion of fuel in the engine 10. A catalytic converter 12 is provided in the exhaust pipe 11 for purifying the exhaust gas. The engine 10 further has a radiator circuit 20 through which engine coolant (hereinafter also referred to as coolant) as a heat medium (second medium) for cooling down the engine 10 is circulated, the waste heat collecting circuit 30 which is formed independently of the radiator circuit 20 and through which the engine coolant is circulated, and a heater circuit 40 through which the engine coolant (hot water) is also circulated for heating air to be blown into a passenger room of the vehicle.

A radiator 21 is provided in the radiator circuit 20 for cooling down the coolant, circulated by a water pump 22, by heat exchange with external air. A bypass passage 23 is provided in the radiator circuit 20 for bypassing the radiator 21. An amount of the coolant flowing into the radiator 21 as well as an amount of the coolant flowing through the bypass passage 23 is adjusted by a thermostat 24. In an engine warming-up operation in particular, the amount of the coolant flowing through the bypass passage 23 is increased to facilitate the warm-up of the engine 10. Namely, super cooling of the engine coolant by the radiator 21 is prevented.

One end of the waste heat collecting circuit 30 is bifurcated from an outlet port of the radiator circuit 20. The engine coolant flows from the engine 10 through the outlet port. The other end of the waste heat collecting circuit 30 is connected to the engine 10, wherein the coolant is circulated through the waste heat collecting circuit 30 by the water pump 22. A water tank 140 (a condensing portion 130) of the waste heat collecting apparatus 100 is provided in the waste heat collecting circuit 30 as described later.

One end of the heater circuit 40 is connected to another outlet port of the engine 10 and the other end of the heater circuit 40 is connected to the waste heat collecting circuit 30 at a position downstream of the waste heat collecting apparatus 100. A heater core 41 is provided in the heater circuit 40 to serve as a heat exchanger for a heater, and the engine coolant (hot water) is also circulated through the heater circuit 40 by the water pump 22. The heater core 41 is arranged in a unit casing (not shown) of an air-conditioning unit, and heats the air blown by a blower fan by heat exchange with hot water.

As shown in FIGS. 2 and 3, the waste heat collecting apparatus 100 is composed of a loop-type heat pipe 101 having a vaporizing portion 110, the condensing portion 130, the valve device 150, and a condensed water returning portion 160, which are connected in this order. An insertion portion (not shown) is provided in the heat pipe 101. The heat pipe 101 is evacuated (depressurized) through the insertion portion, and the insertion portion is tightly closed after working fluid (first medium) is filled into the heat pipe 101. The working fluid in this embodiment is water. The boiling temperature of the water is 100° C. at normal atmosphere (1 atm). However, since the heat pipe 101 is depressurized (e.g. 0.01 atm), the boiling temperature of the working fluid in the heat pipe 101 becomes 5 to 10° C. Alcohol, fluorocarbon, Freon gas and so on may be used as the working fluid (first medium) alternatively.

The condensing portion 130 and the valve device 150 of the heat pipe 101 are arranged in the water tank 140. Each component (to be described) of the waste heat collecting apparatus 100 is made of stainless material having high corrosion resistance. And the components are integrally brazed to each other by brazing with filler metal provided on contacting portions or fitting portions, after the above components are assembled.

The vaporizing portion 110 is composed of tubes 111, fins 112, plate members 113, 114, 115, and so on. Each of the tubes (passages) 111 is formed into a flat tube shape, and a longitudinal axis of the tube 111 extends in a vertical direction. In the present embodiment, the vertical direction is not limited to a direction defined by a gravity, but may be defined as a direction that is generally perpendicular to a floor of the vehicle, on which the waste heat collecting apparatus is mounted. The Multiple tubes 111 are spaced away from each other in a right-left direction in FIG. 2 or 3 at predetermined tube pitches TP. The tubes 111 are composed of three lines of tubes, each of which extends in the up-down direction in FIG. 3. Both longitudinal ends of the tubes 111 are respectively fixed to the lower and upper plate members 113 and 114, each of which has multiple apertures. Multiple plate-type fins 112 made of thin plate material are disposed between outer walls of the tubes 111.

The lower tank plate 115 is provided so as to oppose to the lower plate member 113 and the lower ends of the tubes 111, so that a lower header portion (second header portion) is formed between the lower tank plate 115 and the lower plate member 113. A connecting portion 116 formed between the lower tank plate 115 and the lower plate member 113 is communicated with each lower end of the tubes 111, so that the condensed working fluid is distributed to each of the tubes 111.

A heat insulating plate (insulation wall) 121 is provided, in a similar manner, so as to oppose to the upper plate member 114 and the upper ends of the tubes 111, so that an upper header portion (first header portion) is formed between the heat insulating plate 121 and the upper plate member 114. A connecting portion 117 formed between the heat insulating plate 121 and the upper plate member 114 is communicated with each upper end of the tubes 111, so that the working fluid from each of the tubes 111 is collected in the passage 117. A pair of side plates 118 is provided at both horizontal sides (the right and left sides) of the waste heat collecting apparatus 100 as a reinforcing and fixing member.

An exhaust gas passage, which has a rectangular cross section for example, for exhaust gas is formed in a space surrounded by a surrounding member formed by the upper and lower plate members 114 and 113 and the pair of side plates 118. The exhaust gas flows in a direction perpendicular to the sheet of FIG. 2 through the exhaust gas passage. In other words, exhaust gas flows through the vaporizing portion 110 via the exhaust gas passage in a direction perpendicular to the longitudinal axis of the multiple tubes as shown in a direction indicated by an arrow in FIG. 3.

The water tank (second medium passage) 140 is composed of a water tank plate 141 of a flat shape and a water tank member 142 having a U-shape in its cross section. An inside space defined by the water tank plate 141 and the tank member 142 extends in a direction (left-right direction in FIG. 2), which coincides with the directions of lines of the tubes 111. The water tank 140 is formed at an upper side of the passage 117. An inlet pipe 143 for the coolant is provided at one end (left in FIG. 2) of the water tank 140, and an outlet pipe 144 for the coolant is provided at the other end (right in FIG. 2) of the water tank 140. The condensing portion 130 is arranged in the inside of the water tank 140.

In the condensing portion 130, a fluid passage is formed to have a shape, which is similar to a so-called drawn-cup type heat exchanger, wherein the condensing portion 130 includes multiple tubes 133 arranged onto one another. Each of the multiple tubes is made by joining pairs of tube plates 131 and 132. The tubes 133 comprise multiple passage portions 133a and a pair of tank portions 133b and 133c at both longitudinal ends of the passage portions 133a. Each of the tank portions 133b and 133c is communicated through an aperture at a joint in a direction of building up the tubes 133.

A vapor inlet pipe 134 is provided in the tank portion 133b, wherein one end (a lower end) of the vapor inlet pipe 134 is contracted and communicated with the passage 117 and the other end (an upper end) thereof is extended and opened to an upper space of the tank portion 133b. The upper passage 117 is communicated with the inside space of the tank portion 133b through the vapor inlet pipe 134 and further communicated with the tank portion 133c through the passage portions 133a of the tubes 133. As above, the upper header portion 117 (the upper plate member 114 and the heat insulating plate 121) of the vaporizing portion 110 is communicated with the condensing portion 130 through the vapor inlet pipe 134.

Multiple air spaces are formed between the heat insulating plate 121 of the wave form and the flat-shaped water tank plate 141, wherein each air space functions as an heat insulating portion 120 between the vaporizing portion 110 and the condensing portion 130.

The condensed water returning portion 160 is formed by a return pipe (connecting portion, return passage) 161 and a heat insulating wall (return passage heat insulating wall) 162. The return pipe 161 is a single pipe having a circular cross section, a longitudinal length of which is almost equal to that of the tubes 111. One end (an upper end) of the return pipe 161 extends through the passage 117 and is communicated with an inside of the tank portion 133c of the condensing portion 130, whereas the other end (a lower end) thereof is communicated with the passage 116 (the lower header portion comprising the lower plate member 113 and the lower tank plate 115) of the vaporizing portion 110. The return pipe 161 is arranged in a space formed in the vaporizing portion 110 (namely, in the area of the exhaust gas passage), such that the return pipe 161 is separated from the neighboring tube 111 with a distance equal to the predetermined tube pitch TP, as shown in FIG. 3. It should be noted that the tube pitch TP is defined as a length between a central longitudinal axis of the tube 111 and a central longitudinal axis of the adjacent tube 111, for example. As seen from FIG. 3, the return pipe 161 is arranged in the line of the tubes 111 at a position most downstream of the vaporizing portion 110 in a flow direction of the exhaust gas. Not only one return pipe but multiple return pipes (less than the number of the tubes 111) may be alternatively provided.

The heat insulating wall 162 is arranged at an upstream side of the return pipe 161 in the direction of the flow of exhaust gas. The heat insulating wall 162 is formed into a semi-circular shape or has a C-shaped cross section. However, the heat insulating wall 162 may be formed into a circular shape, so that the heat insulating wall 162 fully covers the return pipe 161.

The valve device 150 is arranged in the tank portion 133c and forms a connecting passage for connecting the passage portion 133a of the tube 133 with the return pipe 161. The valve device 150 is a diaphragm type valve control device for controlling a valve opening degree in accordance with the inner fluid pressure (pressure of the working fluid) in the heat pipe 101.

The valve device 150 is inserted into the tank portion 133c from an upper side of the water tank 140, so that an outer peripheral portion of its lower end extends through the tank portion 133c and the water tank plate 141. The outer peripheral portion of the lower end of the valve device 150 is brought into contact with the heat insulating plate 121, and surrounds the opening end of the return pipe 161. The valve device 150 is arranged in the heat pipe 101 at a downstream side of the condensing portion 130 in a circulation direction of the working fluid.

As shown in FIGS. 4 and 5, the valve device 150 is composed of a housing body 150A, which has an upper casing 151 and a lower casing 152, a diaphragm 153, a spring 154, and a valve body 155.

The housing body 150A is formed into a cylindrical shape and has a large diameter portion at its intermediate portion. An air port 151 a is provided at a top end of the upper casing 151 for communicating the inside of the housing body 150A with the ambient air. A water inlet port 152a is provided or drilled at a side wall of the lower casing 152, through which the condensed water flows into the inside of the housing body 150A. A water outlet port 152b is provided at a lower end of the lower casing 152, through which the condensed water flows out from the housing body 150A. The water outlet port 152b is connected to the upper end of the return pipe 161. The lower casing 152 includes a gate portion (valve seat) 152, which has an aperture 152d between the water inlet and outlet ports 152a and 152b of the lower casing 152.

The diaphragm (driving portion) 153 is disposed between the upper and lower casings 151 and 152 for applying a driving force to the valve body 155. The spring 154 is arranged between the upper casing 151 and the diaphragm 153 for biasing the diaphragm 153 downwardly. The diaphragm 153 is upwardly or downwardly moved, as in FIGS. 4 and 5, in accordance with a force balanced between (a) a downward force (the spring force F and the ambient pressure Pa introduced into the inside of the upper casing 151 through the air port 151a) and (b) an upward force. The upward force is made by the inner pressure Pi of the working fluid in the heat pipe 101 (condensing portion 130), which working fluid being introduced into the lower casing 152 through the water inlet port 152a.

The valve body 155 is formed of a flat disc and arranged to oppose to the lower side of the gate portion 152c. The valve body 155 is integrally connected to the diaphragm 153 via a connecting rod 155a inserted into the aperture 152d. Accordingly, the valve body 155 is moved upwardly or downwardly together with the diaphragm 153 in order to close or open the aperture 152d of the gate portion 152c.

More specifically, when the inner pressure Pi of the working fluid is increased to exceed a first predetermined value Pi1 at a predetermined temperature (e.g. 70° C.) of the engine coolant, the valve device closes its passage. On the other hand, when the inner pressure Pi is decreased to become lower than a second predetermined value Pi2, which is lower than the first predetermined value Pi1, the valve device opens its passage. The first predetermined value Pi1 is also referred to as a valve closing pressure, and the second predetermined value Pi2 is also referred to as a valve opening pressure.

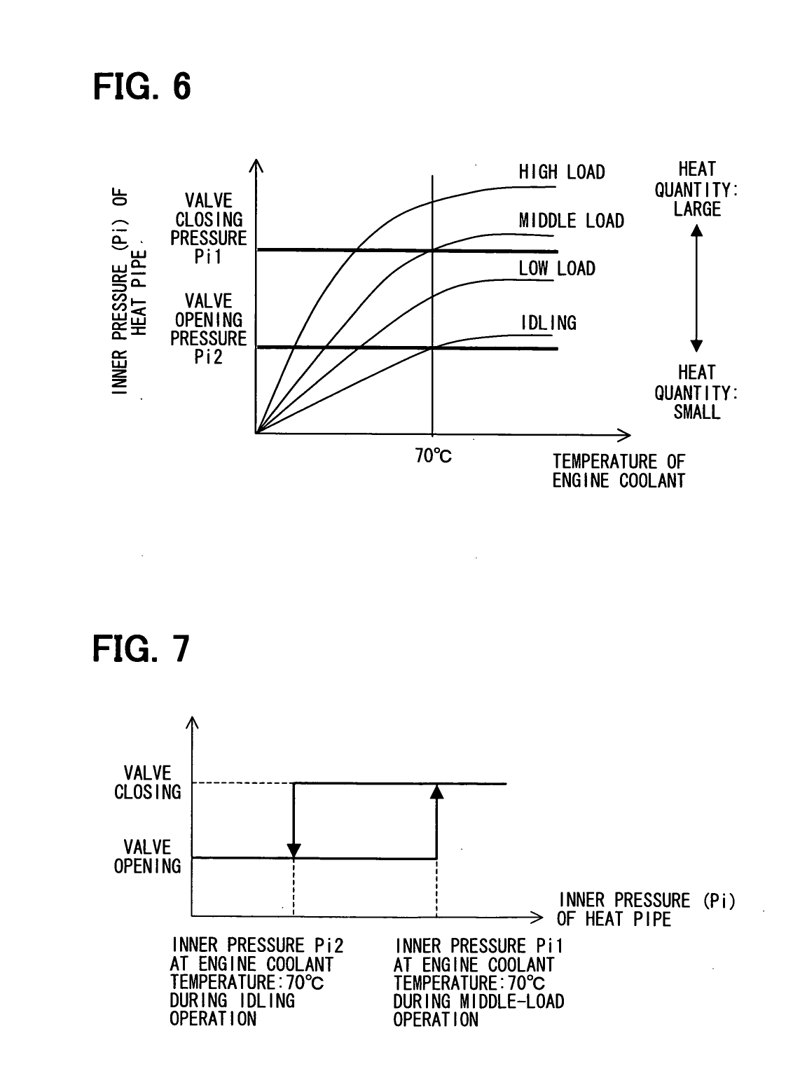

The characteristic feature of valve opening and closing for valve body 155 in the valve device 150 will be further explained. FIG. 6 shows a relation between the temperature of the coolant for the engine 10 and the inner pressure Pi of the heat pipe 101, with respect to the heat quantity of the exhaust gas. The inner pressure Pi of the heat pipe 101 is increased as the temperature of the engine coolant is increased. The inner pressure Pi of the heat pipe 101 is also increased as the heat quantity of the exhaust gas is increased. The heat quantity of the exhaust gas varies depending on the operational condition of the engine, so that the heat quantity becomes higher at a high-load engine operation whereas the heat quantity becomes lower at a low-load engine operation.

As shown in FIG. 7, the valve opening and closing operation of the valve device 150 has a hysteresis. Namely, the valve device 150 closes its passage or is closed at the first predetermined pressure Pi1 for the inner pressure, which is attained by the heat quantity during a middle-load engine operation at the temperature of 70° C. of the engine coolant. And the valve device 150 opens its passage or is opened at the second predetermined pressure Pi2 for the inner pressure, which is attained by the heat quantity during an engine idling operation at the temperature of 70° C. of the engine coolant. The water is used as the working fluid for the heat pipe 101 in this embodiment. Therefore, according to the temperature of the coolant for the engine 10 and the heat quantity of the exhaust gas, the first predetermined pressure Pi1 is selected as a value of 0.1 Mpa, whereas the second predetermined pressure Pi2 is selected as a value of 0.05 MPa.

The temperature of the saturated vapor for the water corresponds to 100° C. at the inner pressure Pi of 0.1 MPa. In most cases, the engine coolant is controlled at around 100° C. by the radiator 21. Therefore, when the inner pressure Pi is higher than 0.1 MPa, an operation for collecting the waste heat from the exhaust gas by the engine coolant is stopped by closing the valve body 155 or by displacing the valve body 155 to a closing position to close the connecting portion 161, as explained below. Also, the temperature of the saturated vapor for the water corresponds to 80° C. at the inner pressure Pi of 0.05 MPa. The operation for collecting the waste heat from the exhaust gas by the engine coolant is actively carried out by opening the valve body 155 or by displacing the valve body 155 to an opening position to open the connecting portion 161, when the inner pressure Pi is between 0.05 MPa and 0.1 MPa (the temperature of the engine coolant is between 80 to 100° C.).

According to the waste heat collecting apparatus 100 of the above embodiment, the vaporizing portion 110 is arranged in the exhaust pipe 11 at a downstream side of the catalytic converter 12, and the inlet and outlet pipes 143 and 144 of the water tank 140 are connected to the waste heat collecting circuit 30 (FIG. 1).

Now, an operation of the waste heat collecting apparatus 100 according to the above structure will be explained.

When the engine operation is started, the water pump 22 is activated by the engine 10, so that the engine coolant starts its circulation in the radiator circuit 20, the waste heat collecting circuit 30, and the heater circuit 40. The exhaust gas combusted in the engine 10 flows through the catalytic converter 12 in the exhaust pipe 11 and is emitted to the atmosphere, wherein the exhaust gas passes through the vaporizing portion 110 (the exhaust gas passage defined by the plate members 113, 114, 118) of the waste heat collecting apparatus 100. The engine coolant circulating in the waste heat collecting circuit 30 flows through the water tank 140 (the condensing portion 130) of the waste heat collecting apparatus 100.

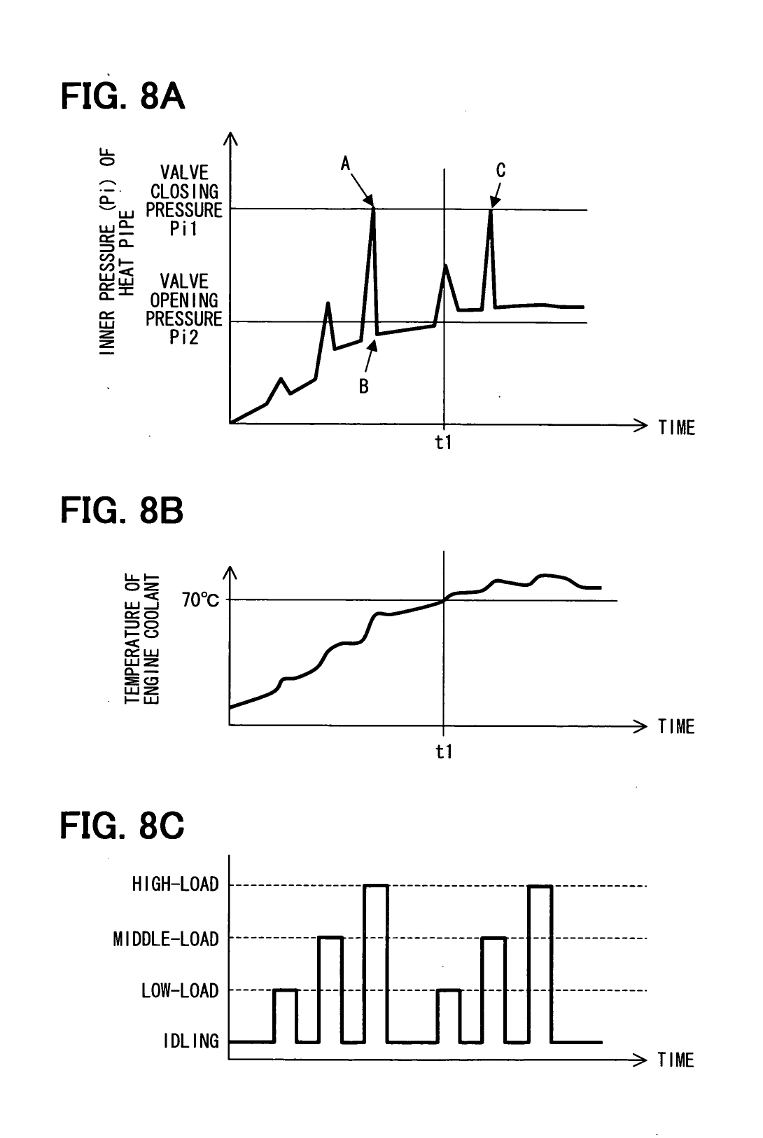

After the engine 10 has been started, the temperature of the engine coolant increases as shown in FIG. 8B, the inner pressure Pi of the heat pipe 101 is gradually increased as shown in FIG. 8A, and the heat quantity of the exhaust gas varies depending on the engine load as shown in FIG. 8C. Accordingly, in a vehicle with an ordinary engine, the inner pressure Pi of the heat pipe varies in accordance with the various engine operational conditions, such as a vehicle acceleration, a vehicle deceleration, a vehicle stop, and so on (as indicated by projecting points in FIG. 8A).

When the inner pressure Pi of the heat pipe 101 is lower than the valve closing pressure Pi1, the valve body 155 of the valve device 150 opens the aperture 152d, as already explained with reference to FIG. 7. Therefore, the water (working fluid) in the heat pipe 101 receives the heat at the vaporizing portion 110 from the exhaust gas flowing through the exhaust pipe 11, to start the vaporization. The working fluid (steam) upwardly flows in the tubes 111, and flows into the condensing portion 130 (the tank portion 133b and the intermediate passage portion 133a) through the passage 117 and the vapor inlet pipe 134. The steam flowing into the condensing portion 130 is then cooled down by the engine coolant flowing from the waste heat collecting circuit 30 into the water tank 140, and condensed to the condensed water. The condensed water flows into the passage 116 of the vaporizing portion 110 through the water inlet port 152a of the valve device 150, the aperture 152d opened by the valve body 155, the water outlet port 152b, and the return pipe 161. The condensed water flowing through the return pipe 161 is prevented by the heat insulating wall 162 from vaporizing due to the heat from the exhaust gas, and thereby realizing smooth circulation of the working fluid.

As above, the heat from the exhaust gas is transmitted to the working fluid, and transferred from the vaporizing portion 110 to the condensing portion 130. The heat is emitted as the condensation latent heat, when the steam is condensed to the water at the condensing portion 130, so that the engine coolant flowing through the waste heat collecting circuit 30 is heated. Accordingly, the operation for warming up the engine 10 is facilitated. A friction loss in the engine 10 is thereby reduced. Furthermore, a decrease of friction loss of the engine 10, an increase of fuel amount, which is otherwise necessary for improving a smooth starting operation as well as a quick warming operation for the engine, can be suppressed. As a result, a fuel consumption ratio is improved. In addition, a heating performance by the heater core 41 is improved. Also, some of the heat from the exhaust gas is transferred from the vaporizing portion 110 to the condensing portion 130 by heat conduction through the outer wall surface of the heat pipe 101.

When the inner pressure Pi of the heat pipe 101 exceeds the valve closing pressure Pi1, as indicated by a point A in FIG. 8, the valve body 155 temporarily closes the aperture 152d. The condensed water is thereby prevented from flowing into the return pipe 161, so that the circulation of the working fluid in the heat pipe 101 is stopped. Namely, the collection of the waste heat is stopped. Then, the inner pressure Pi of the heat pipe 101 is decreased. When the inner pressure Pi becomes lower than the valve opening pressure Pi2, as indicated by a point B in FIG. 8, the valve body 155 again opens the aperture 152d, to re-start the operation of the waste heat collection.

When the temperature of the engine coolant exceeds 70° C. after the point B (at a time point of t1 in FIG. 8B), and when the inner pressure Pi becomes higher than the valve closing pressure Pi1, as indicated by a point C in FIG. 8A, the valve body 155 again closes the aperture 152d. As a result, the inner pressure Pi is decreased due to the stop of the operation of the heat pipe 101. So long as the engine 10 is in its operation, the heat quantity of the exhaust gas does not become lower than that at the engine idling operation. This means that the inner pressure Pi of the heat pipe 101 does not become lower than the valve opening pressure Pi-2. Therefore, the aperture 152d is not opened by the valve body 155 after this, and the operation for the waste heat collection is continuously stopped.

When the engine 10 is stopped, there exists no longer the heat quantity of the exhaust gas, and the temperature of the engine coolant is also decreased. The inner pressure Pi of the heat pipe 101 is thereby decreased to be lower than the valve opening pressure Pi2, and the valve body 155 opens the aperture 152d to enable the next waste heat collection.

As above, according to the waste heat collecting apparatus 100 of the present embodiment, the valve device 150 is arranged at the downstream side of the condensing portion 130 in the circulation direction of the working fluid. The valve device 150 is composed of the diaphragm 153 and the valve body 155, which moves integrally with the diaphragm 153 to open and close the passage in the heat pipe 101. The diaphragm 153 serves as an driving portion that is actuated or operated when the driving portion senses the inner pressure Pi in the heat pipe 101. Accordingly, the structure of the valve device 150 is simpler than the one in the description of the related art. Furthermore, since the operation for the waste heat collection is stopped depending on the inner pressure Pi, which is decided in accordance with the temperature of the engine coolant and the heat quantity of the exhaust gas, an overheating of the engine coolant by the exhaust gas can be avoided. Namely, because the valve device 150 adjusts the flow amount of the working fluid from the condensing portion 130 to the vaporizing portion 110, excessive collection of heat quantity is avoided, and thereby an overheat of the engine can be avoided.

In addition, the valve body 155 is provided with a hysteresis characteristic for opening and closing operation. Namely, the aperture 152d is closed when the inner pressure Pi of the heat pipe 101 is higher than the valve closing pressure Pi1, whereas the aperture 152d is opened when the inner pressure Pi of the heat pipe 101 is lower than the valve opening pressure Pi2. Accordingly, a hunting between the valve closing position and valve opening position of the valve body 155 can be prevented, even when a small variation for the inner pressure Pi of the heat pipe 101 occurs. As a result, a stable operation for the waste heat collection and a stable stopping operation of the waste heat collection can be realized.

The waste heat collecting apparatus 100 of the present invention can be applied to a hybrid electric vehicle. In the hybrid electric vehicle, the engine operation is often temporally stopped even when the vehicle is running. Therefore, the temperature of the engine coolant may be decreased during the running of the vehicle. The inner pressure Pi of the heat pipe 101 varies in a more complicated manner compared with a general vehicle, so that the start and stop of the waste heat collecting operation may be repeated more often than the general vehicle. However, according to the present invention, the overheat of the engine coolant is likewise prevented and the overheat of the engine for the hybrid electric vehicle can be surely prevented.

According to the present embodiment, multiple tubes 111 are provided in the vaporizing portion 110, so that a heat receiving area with respect to the exhaust gas is increased to facilitate the vaporization of the working fluid at the vaporizing portion 110. The heat transferring amount from the vaporizing portion 110 to the condensing portion 130 is thereby increased.

In addition, the heat insulating portion 120 is provided between the vaporizing portion 110 and the condensing portion 120, so that the vaporizing portion 110 is prevented from being cooled down by the engine coolant flowing through the condensing portion 130. Therefore, the condensing operation in the vaporizing portion 110 is suppressed. A proper heat transfer can be realized, even when the condensing portion 130 is provided closely to and at the upper side of the vaporizing portion 110. The heat insulating portion 120 is formed by the multiple air spaces formed by providing the heat insulating plate 121 between the vaporizing portion 110 and the condensing portion 130. The above air space provides a heat insulating effect. As a result, the heat insulating portion 120 is formed with a simple structure.

In addition, the longitudinal length of the return pipe 161 is made to be almost equal to that of the tubes 111, so that the condensing portion 130 can be assembled to the vaporizing portion 110 in a compact manner. Furthermore, the return pipe 161 is arranged in the space defined in the vaporizing portion 110 (the exhaust gas passage area) together with multiple tubes 111, so that the return pipe 161 can be assembled together with the multiple tubes 111. As a result, a manufacturing process for the waste heat collecting apparatus 100 is made simpler.

In addition, the heat insulating wall 162 is provided at least at the upstream side the return pipe 161 in a direction of the exhaust gas flow, so that the heat transfer from the exhaust gas to the condensed water flowing through the return pipe 161 is suppressed. Therefore, the vaporization of the condensed water in the return pipe 161 can be suppressed, to achieve a smooth return flow of the condensed water from the condensing portion 130 to the vaporizing portion 110.

In addition, the return pipe 161 is arranged downstream of the line of the tubes 111 in the exhaust gas flow direction. Because the exhaust gas heats the water in the multiple tubes 111, the temperature of the exhaust gas becomes lower, as the exhaust gas flows in the downstream direction. Accordingly, the vaporization of the condensed water in the return pipe 161 is further suppressed.

As above, the waste heat collecting apparatus 100 can be obtained, which has a high performance for the heat transfer, which is compact in size, and which can avoid an excessive collection of the waste heat with a simple structure.

According to the first embodiment, the valve closing pressure of the valve body 155 for the valve device 150 is selected as the value of 0.1 MPa, whereas the valve opening pressure thereof is selected as the value of 0.05 MPa. However, the other values may be selected for the valve closing and opening pressures. For example, the valve opening pressure may be selected as the value of 0.6 kPa, while the valve closing pressure may remains the same value of 0.1 Mpa with the temperature of the saturated vapor for the water in the heat pipe 101 as the upper limit. In the case where the valve opening pressure is selected as the value of 0.6 kPa, the temperature of the saturated vapor for the water corresponds to 0° C. Since the water may not be frozen above that temperature (above that pressure), this value (0.6 kPa) can be regarded as one of fundamental conditions for performing the heat transfer operation. In other words, since the water may not be frozen above that pressure, this value can be regarded as one of conditions for performing the basic heat transfer operation by the vaporization and condensation in the heat pipe 101. In the case of 0.6 kPa for the valve opening pressure, the range for the waste heat collecting operation with respect to the coolant can be enlarged to its maximum value.

### Second Embodiment

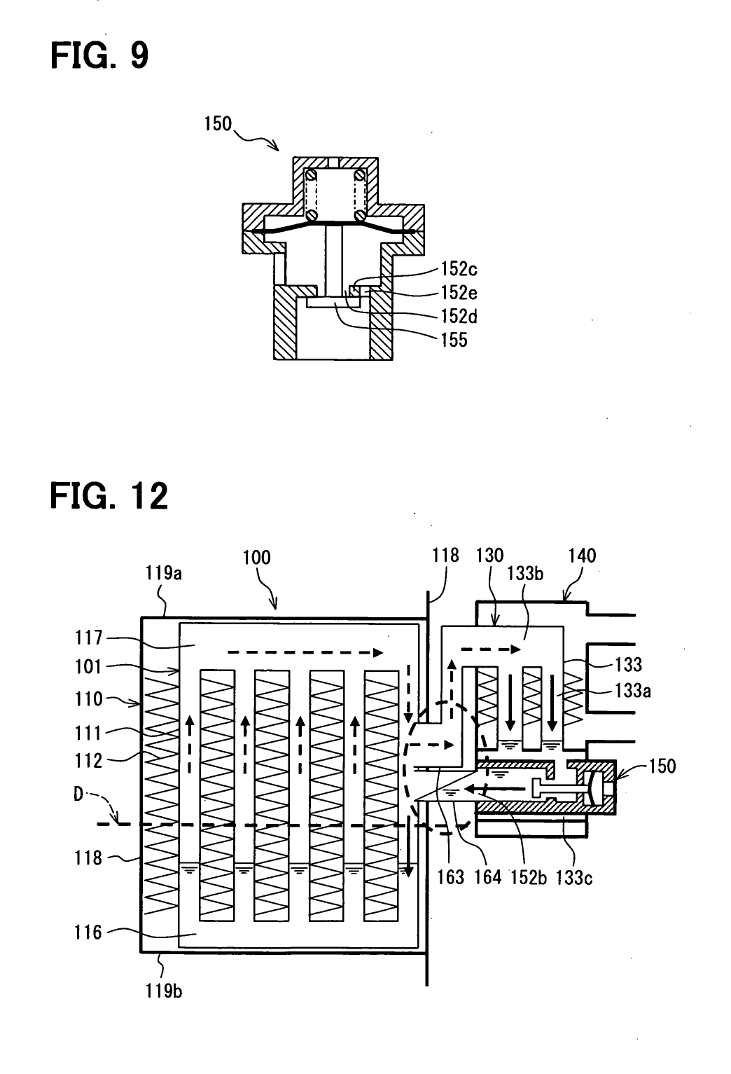

FIG. 9 shows a second embodiment of the present invention. The valve device 150 of the second embodiment differs from that of the first embodiment in that a minute aperture 152e is provided at the gate portion 152c. According to such a modification, even when the aperture 152d is fully closed by the valve body 155, a small amount of the condensed water may return from the condensing portion 130 to the vaporizing portion 110. In the case where the engine 10 is operating at its high-load but the radiator 21 has an additional coverage (e.g., additional capacity) for the cooling operation, the waste heat collecting operation is carried out by the circulation of the working fluid through the minute aperture 152e. The size of the minute aperture 152e is decided depending on the additional coverage at the radiator 21, such that the overheat can be avoided even when the certain amount of the working fluid is circulated through the minute aperture 152e.

As above, the small amount of the condensed fluid from the condensing portion 130 can be circulated through the minute aperture 152e even when the aperture 152d is fully closed by the valve body 155. Since the condensed fluid flows from the condensing portion 130 to the vaporizing portion 110, the vaporizing portion 110 can be cooled, to thereby improve a heat resisting performance of the waste heat collecting apparatus 100.

### Third Embodiment

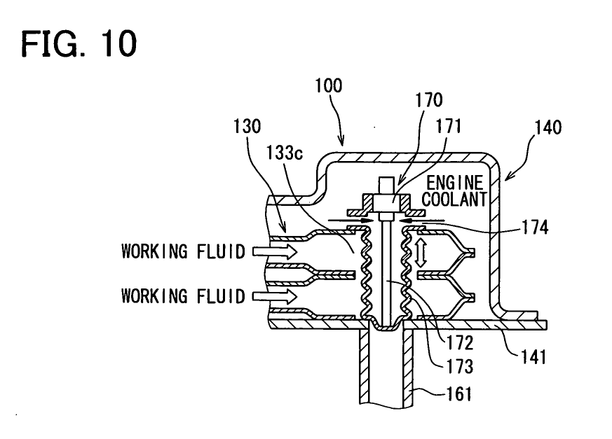

FIG. 10 shows a third embodiment of the present invention. The diaphragm-type valve device 150 of the first embodiment is replaced by a valve device 170 of a thermo-wax type, wherein the valve device 170 opens and closes the passage depending on the temperature of the engine coolant.

To be specific, the valve device 170 is composed of a thermo-wax portion 171, a connecting rod 172, and a bellows 173. A wax is filled into the thermo-wax portion 171, which is expanded or contracted depending on the temperature of the coolant. One end (upper end) of the long slender connecting rod 172 is inserted into the thermo-wax portion 171, and the other end is extended downwards. The connecting rod 172 is moved downwardly or upwardly as in FIG. 10 depending on the expansion or contraction of the wax. That is, the connecting rod 172 slides downwardly due to the expansion of the wax and slides upwardly due to the contraction of the wax. The thermo-wax portion 171 and the connecting rod 172 serve as a driving portion for the valve device 170.

The bellows 173 acts as a valve body for the valve device 170. The bellows 173 is made of a metal in the form of a pleated flexible member and is extendable in a longitudinal direction. One end (upper end) of the bellows 173 has an open end and the other end (lower end) is closed. The connecting rod 172 and the thermo-wax portion 171 are inserted into the upper open end of the bellows 173, and the lower end of the connecting rod 172 is connected to the lower end of the bellows 173. The lower end of the thermo-wax portion 171 is housed or received in the bellows 173. The upper end thereof protrudes into the outside of the bellows 173. The thermo-wax portion 171 is connected to the open end of the bellows 173 to close the open end and fixed there. Multiple communication ports 174 (for, example, two communication ports 174) are provided close to the lower end of the thermo-wax portion 171 of the bellows 173, for communicating the inside of the bellows 173 with the outside thereof.

The valve device 170 is arranged in the tank portion 133c of the condensing portion 130, such that the thermo-wax portion 171 is arranged at the upper outer side of the tank portion 133c, and the communication ports 174 are opening to the space outside of the tank portion 133c. The lower end of the bellows 173 is arranged to oppose to a valve seat formed in the water tank plate 141, at which the tank portion 133c is connected to the return pipe 161.

The upper portion of the thermo-wax portion 171 is exposed to the engine coolant in the water tank 140. The coolant flows into the inside of the bellows 173 through the communication ports 174, so that the lower portion of the thermo-wax portion 171 as well as the connecting rod 172 are exposed to the coolant.

When the temperature of the coolant is low, the wax of the thermo-wax portion 171 is contracted and the connecting rod 172 is slidably moved accordingly in the upward direction. The lower end of the bellows 173 is also slidably moved upwardly together with the connecting rod 172 so that the valve device 170 opens the passage of the return pipe 161. Namely, the condensing portion 130 is communicated with the return pipe 161 to carry out the waste heat collecting operation by the apparatus 100.

When the temperature of the coolant is increased, the wax of the thermo-wax portion 171 is expanded and the connecting rod 172 is slidably moved in the downward direction. The lower end of the bellows 173 is also slidably moved downwardly together with the connecting rod 172. The valve device 170 closes the passage or the opening of the return pipe 161 when the temperature of the coolant exceeds a predetermined temperature. Accordingly, the communication between the condensing portion 130 and the vaporizing portion 110 is cut off to stop the waste heat collecting operation by the apparatus 100.

As above, according to the third embodiment, the start or stop of the waste heat collecting operation is carried out depending on the temperature of the coolant, so that the control for the temperature of the coolant becomes easier. Furthermore, since the coolant flows into the inside of the bellows 173 through the communication ports 174, the entire thermo-wax portion 171 (and the connecting rod 172) is exposed to the coolant. As a result, the valve opening and closing operation of the valve body (bellows 173) is not affected by the temperature of the working fluid. Therefore, a more accurate control of the valve opening and closing operation depending on the temperature of the coolant can be realized.

### Fourth Embodiment

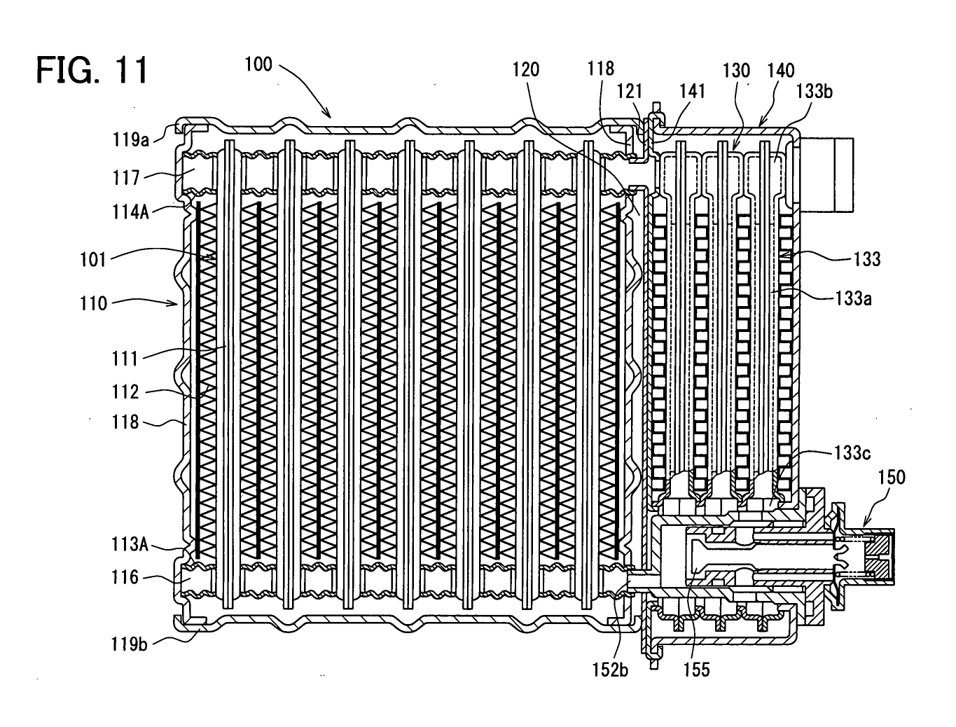

FIG. 11 shows a fourth embodiment of the invention. In the waste heat collecting apparatus 100 according to the fourth embodiment, a position of the condensing portion 130 relative to the vaporizing portion 110 is modified, when compared with the first embodiment. The same reference numerals are used in the fourth embodiment to designate the same or similar parts and devices of the first embodiment.

The tubes 133 of the condensing portion 130 are arranged to be parallel to the tubes 111 of the vaporizing portion 110. Namely, the tubes 133 vertically extend, and the condensing portion 130 is arranged at a horizontal side portion (right side in FIG. 11) of the vaporizing portion 110.

In the fourth embodiment, each of the tubes 111 of the vaporizing portion 110 is a plate tube made of a pair of plate members, and corrugated fins 112 are disposed between the neighboring tubes 111. A lower header portion 113A of a cylindrical shape is provided at the lower ends of the respective tubes 111 to form the lower passage 116. In the same manner, an upper header portion 114A of a cylindrical shape is provided at the upper ends of the respective tubes 111 to form the upper passage 117.

The pair of side plates 118 is provided at both horizontal sides of the vaporizing portion 110. An upper plate 119a and a lower plate 119b are provided at both vertical sides of the vaporizing portion 110. The exhaust gas passage of a rectangular shape is formed by those plates 118, 119a and 119b.

At a joint between the upper header portion 114A of the vaporizing portion 110 and the tank portion 133b of the condensing portion 130, the vapor inlet pipe 134 of the first embodiment is not provided. Therefore, the upper header portion 114A is directly connected to the tank portion 133b.

The valve device 150 is provided at the lower end of the condensing portion 130 and connected to the lower tank portion 133c (the downstream side tank). The water outlet port 152b of the valve device 150 is directly connected to the lower header portion 113A of the vaporizing portion 110.

The operation and effects of the waste heat collecting apparatus 100 of the fourth embodiment are the same as those in the first embodiment. In addition, the longitudinal direction of the tubes 133 of the condensing portion 130 is arranged in the same direction of the tubes 111 of the vaporizing portion 110, and the condensing portion 130 is arranged at the horizontal side of the vaporizing portion. Accordingly, the lower head portion 113A of the vaporizing portion 110 can be arranged to oppose the tank portion 133c (valve device 150) of the condensing portion 130. As a result, the return pipe 161 (together with the heat insulating wall 162) of the first embodiment can be eliminated, making it possible to connect the downstream side of the condensing portion 130 with the upstream side of the vaporizing portion 110, thereby reducing the number of components.

### Fifth Embodiment

FIG. 12 shows a fifth embodiment of the present invention. In the waste heat collecting apparatus 100 according to the fifth embodiment, the fluid connecting portion for connecting the vaporizing portion 110 with the condensing portion 130 is modified, and the position of the valve device 150 is modified, in comparison with the fourth embodiment. Further, the same reference numerals are used in the waste heat collecting apparatus 100 of the fifth embodiment to designate the same or similar parts and devices of the fourth embodiment.

The fluid connecting portion is composed of a fluid flow-in passage (entry passage) 163 and a fluid flow-out passage (return passage) 164, as shown in FIG. 12, wherein the fluid connecting portion is circled by a dotted line. The fluid flow-in passage 163 is a passage portion for allowing the working fluid (steam) vaporized at the vaporizing portion 110 to flow into the condensing portion 130. For that purpose, the fluid flow-in passage 163 connects one of the tubes 111 of the vaporizing portion 110, which is arranged at a side close to the condensing portion 130, with one of the tubes 133 of the condensing portion 130, which is arranged at a side close to the vaporizing portion 110.

The fluid flow-out passage 164 is a passage portion for returning the condensed water condensed at the condensing portion 130 to the lower passage 116 of the vaporizing portion 110. For that purpose, the fluid flow-out passage 164 connects the condensed water outlet port 152b of the valve device 150 with the tube 111 of the vaporizing portion 110, which is arranged at the side close to the condensing portion 130.

The fluid flow-in and flow-out passages 163 and 164 are arranged closer to each other, in a range in which the passages 163 and 164 are connectable to the tube 111. The fluid flow-in passage 163 is arranged at such a position, which is higher in a vertical direction than a liquid level D of the water (working fluid) in the vaporizing portion 110. The liquid level D here corresponds to a level of the working fluid during the non-operation of the waste heat collecting apparatus 100, wherein the working fluid is not vaporized by the exhaust gas and substantially all of the working fluid is condensed to the water and stored in the vaporizing portion 110.

The valve device 150 is also arranged at the position, which is higher in the vertical direction than the liquid level D of the water. As the fluid flow-out passage 164 is connected to the valve device 150, the fluid flow-out passage 164 is likewise arranged at the position higher than the liquid level D in the vertical direction. A lower end of the condensing portion 130 is designed to be aligned with the valve device 150. Accordingly, the lower end of the condensing portion 130 is higher than the lower end of the condensing portion 110 in the vertical direction.

The waste heat collecting apparatus 100 of the fifth embodiment has the same operation and effects to the fourth (i.e. the first) embodiment. In addition, as passages, the fluid flow-in and flow-out passages 163 and 164 are arranged closer to each other, so that heat stress generated at the passage portions 163 and 164 can be reduced.

In the passage portions 163 and 164 for connecting the vaporizing portion 110 and the condensing portion 130 with each other, heat stress (i.e. thermal deformation) is generated by the temperature difference between the exhaust gas passing through the vaporizing portion 110 and the coolant flowing through the condensing portion 130. The heat stress becomes larger, as a distance between the passage portions 163 and 164 becomes longer. However, the distance between the passage portions 163 and 164 can be made shorter by arranging them closer to each other. As a result, the heat stress generated at the passage portions 163 and 164 can be reduced.

The fluid flow-in passage 163 is arranged at the position higher than the liquid level D of the water, so that the fluid flow-in passage 163 may not be filled with the water, and thereby the steam vaporized at the vaporizing portion 110 may not be held within the space of the vaporizing portion 110.

As the valve device 150 is also arranged at the position higher than the liquid level D, the function of the valve device 150 may not be blocked by frost of the water. In other words, in the case where the valve device 150 was arranged at a position lower than the liquid level D of the water in a comparison example, the valve device 150 may be frozen together with the water when the waste heat collecting apparatus 100 is not operated in a low-temperature environment. When the valve device 150 is frozen, the on-off operation thereof can not be carried out, and the circulation of the working fluid (steam, condensed water) in the waste heat collecting apparatus 100 is thereby blocked until the surrounding portion of the valve device 150 has been defrosted. Namely, the waste heat collecting apparatus 100 cannot start its operation when the valve device 150 is frozen with water inside thereof. According to the above embodiment, however, the above problem does not occur, because the valve device 150 is arranged at the position higher than the liquid level D of the water so that it may not be frozen together with the water.

According to the above embodiment, the valve device 150 is arranged at the position higher than the liquid level D of the water, and the lower end of the condensing portion 130 is arranged at the position higher than the lower end of the condensing portion 110 in the vertical direction. Accordingly, all of the water in the apparatus 100 can be substantially pooled in the vaporizing portion 110 (no water is held in the condensing portion 130), when the waste heat collecting apparatus 100 is not operated. This means that the amount of the water to be charged into the apparatus 100 can be made smaller. Furthermore, the size of the condensing portion 130 can be made smaller by an amount that corresponds to the decrease in the amount of water originally charged, even in consideration of such a situation, in which all of the condensed water should be held in the condensing portion 130 during the operation of the apparatus 100 in which the valve device 150 is closed.

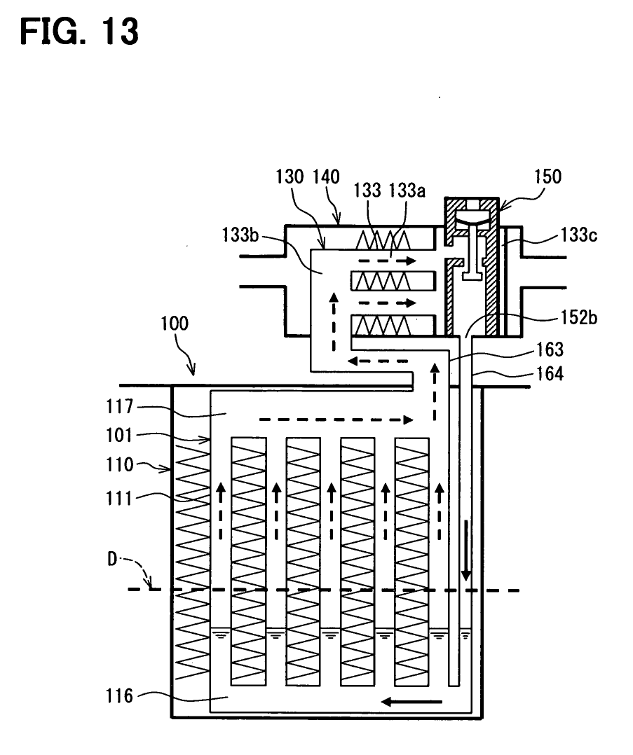

FIG. 13 shows a modification of the fifth embodiment. In this modification, the condensing portion 130 is arranged at an upper side of the vaporizing portion 110, wherein positions of the passage portions 163 and 164 as well as the valve device 150 are changed. The condensing portion 130 is rotated by 90 degrees, when compared with that in the fifth embodiment and is arranged at the upper side of the vaporizing portion 110.

The fluid flow-in passage 163 is a passage for connecting the passage 117 of the vaporizing portion 110 with one of the tubes 133 of the condensing portion 130, which is arranged at a side close to the vaporizing portion 110. The fluid flow-out passage 164 is a long slender passage portion for connecting the condensed water outlet port 152b of the valve device 150 with the lower passage 116 of the vaporizing portion 110. The passage portions 163 and 164 are arranged closer to each other. According to the above modification, the fluid flow-in passage 163 as well as the valve device 150 is arranged at the position higher than the liquid level D of the water, so that the same effects of the fifth embodiment can be obtained.

### Sixth Embodiment

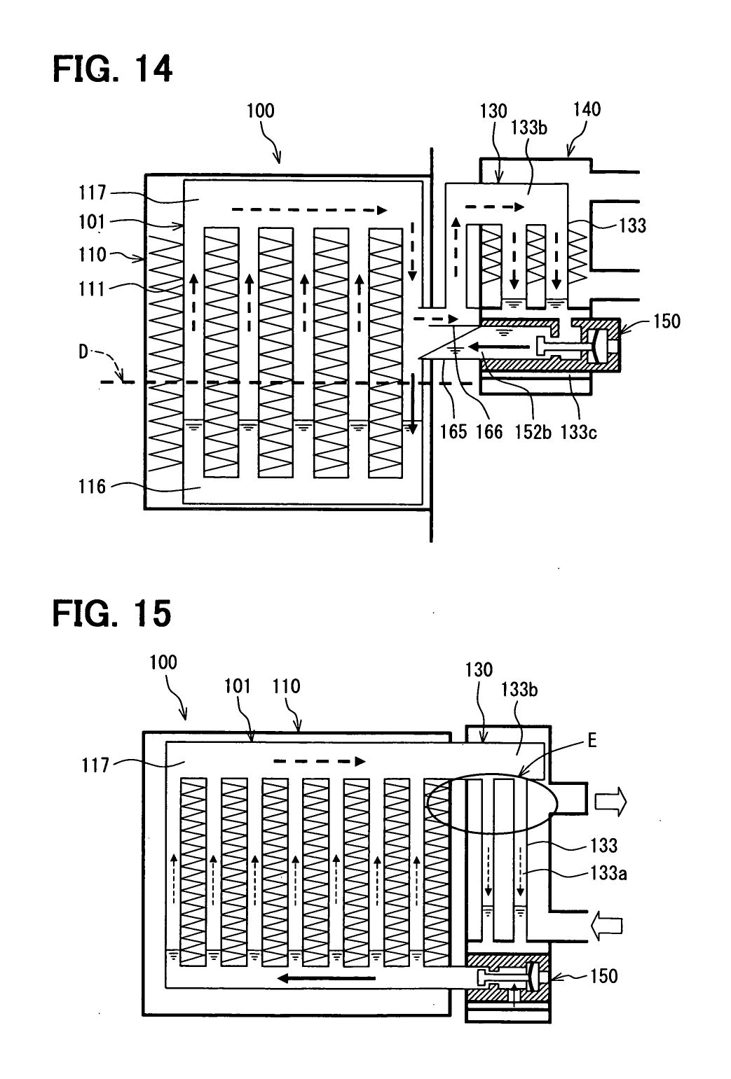

FIG. 14 shows a sixth embodiment of the present invention, in which the passages 163 and 164 as the fluid connecting portion in the fifth embodiment are formed by one fluid pipe 165. The same reference numerals are used in the waste heat collecting apparatus 100 of the sixth embodiment to designate the same or similar parts and devices of the fifth embodiment.

The fluid pipe 165 is extended such that the water outlet port 152b of the valve device 150 is communicated with the tube 111 of the vaporizing portion 110, which is arranged at the side close to the condensing portion 130. An upper portion of the fluid pipe 165 is communicated with the tube 133 of the condensing portion 130, which is arranged at the side close to the vaporizing portion 110. The fluid pipe 165 is also arranged at the position higher than the liquid level D of the water.

A partitioning wall 166 is formed in the inside of the fluid pipe 165 for separating the space of the pipe 165 into an upper space and a lower space. As a result, the tube 111 of the vaporizing portion 110 is communicated with the tube 133 of the condensing portion 130 through the upper space formed in the fluid pipe 165 by the partitioning wall 166. In the similar manner, the condensed water outlet port 152b of the valve device 150 is communicated with the tube 111 of the vaporizing portion 110 through the lower space formed in the fluid pipe 165 by the partitioning wall 166.

According to the above sixth embodiment, the fluid flow-in and flow-out passage portions are formed in the single fluid pipe 165. Therefore, as compared with the fifth embodiment in which two passage portions (163, 164) are provided, the distance between the two passage portions (163, 164) is substantially zero. Accordingly, the heat stress can be further reduced.

In addition, the partitioning wall 166 is provided in the fluid pipe 165. Accordingly, in the passage 165, a direct contact between the steam vaporized at the vaporizing portion 110 and the condensed water cooled and condensed at the condensing portion 130 is prevented by the partitioning wall 166. It is, therefore, avoided that the steam from the vaporizing portion 110 is cooled down (condensed) by the condensed water before entering the condensing portion 130.

However, the partitioning wall 166 may not be provided, in the case where a degree of influence caused by the direct contact between the steam and the condensed water is relatively small in the passage 165.

### Seventh Embodiment

A seventh embodiment of the present invention is shown in FIGS. 15 to 18, in which, as compared with the fourth embodiment, a reverse flow limiting means is provided in the condensing portion 130, so that a reverse flow of the condensed water to the vaporizing portion 110 is suppressed.

The reverse flow limiting means is provided at an upstream side of the condensing portion 130, namely, at an upstream side of an intermediate passage portion 133a of the tubes (passage for the working fluid or first medium) 133. The upstream side is indicated by a circle E in FIG. 15.

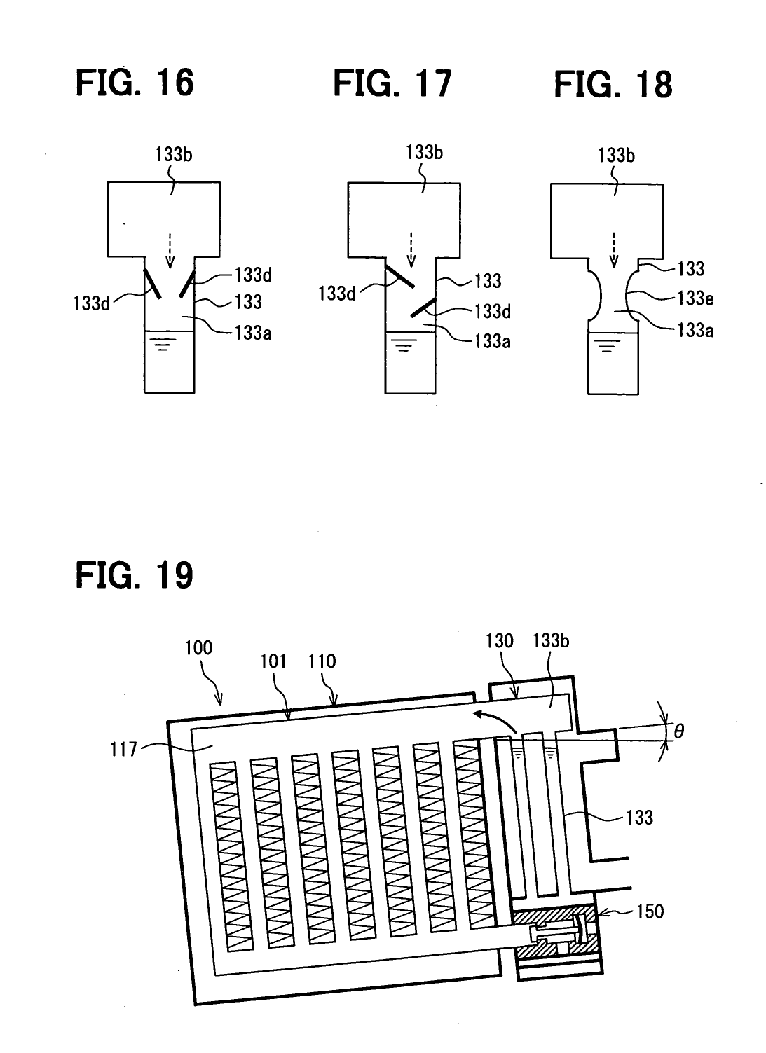

The reverse flow limiting means is, for example, formed as multiple plate members 133d, as shown in FIG. 16. Each plate member 133d is provided at an inner wall of the intermediate passage portion 133a, such that the plate member 133d is inclined in a direction of a flow of the steam, which flows in from the vaporizing portion 110. In other words, the plate member 133d projects from the inner wall of the intermediate passage portion 133a and is angled relative to a flow direction of the working fluid (first medium) such that the plate member 133d extends toward the valve device 150. Multiple plate members 133d are provided to oppose to each other. The multiple plate members 133d may be alternately provided at the inner wall of the intermediate passage portion 133a, in the direction of the steam flow, as shown in FIG. 17. The reverse flow limiting means may be formed as a restricting portion 133e, so that an inner diameter or a cross-sectional area of the intermediate passage portion 133a is reduced, as shown in FIG. 18.

As already explained in the first embodiment, in the waste heat collecting apparatus 100, the valve device 150 is closed, when the inner pressure Pi of the working fluid in the heat pipe 101 is increased to exceed the valve closing pressure Pi1, as a result that the vaporization of water has been continuously carried out in the vaporizing portion 110. The re-circulation of the condensed water in the heat pipe 101 (the condensing portion 130) is stopped. In such a situation, the vaporizing portion 110 is in a condition of a so-called “empty-heating”, in which the vaporizing portion 110 is heated while the water (working fluid) is not sufficiently filled therein. As a result, the temperature of the vaporizing portion 110 may be increased to an extremely high value. In a case, where the waste heat collecting apparatus 100 is inclined (e.g. by an angle ,, in FIG. 19) in the above situation because of a vehicle travel on a sloping road, or a vibration that is applied to the apparatus 100 during the vehicle travel, the condensed water in the condensing portion 130 may be returned to the vaporizing portion 110.

In the case where the condensed water was returned to the vaporizing portion 110, which is in the condition of the “empty-heating”, as in a direction indicated by an arrow in FIG. 19, the vaporizing portion 110 would be rapidly cooled down, so that the heat stress may occur. Furthermore, the returned condensed water may be vaporized at once to increase the pressure in the vaporizing portion 110. The heat transfer may be completed in the vaporizing portion 110, which deteriorates the strength as well as the function of the heat collecting apparatus 100. According to the seventh embodiment, however, the above drawbacks can be overcome by the reverse flow limiting means (133d, 133e).

### Eighth Embodiment

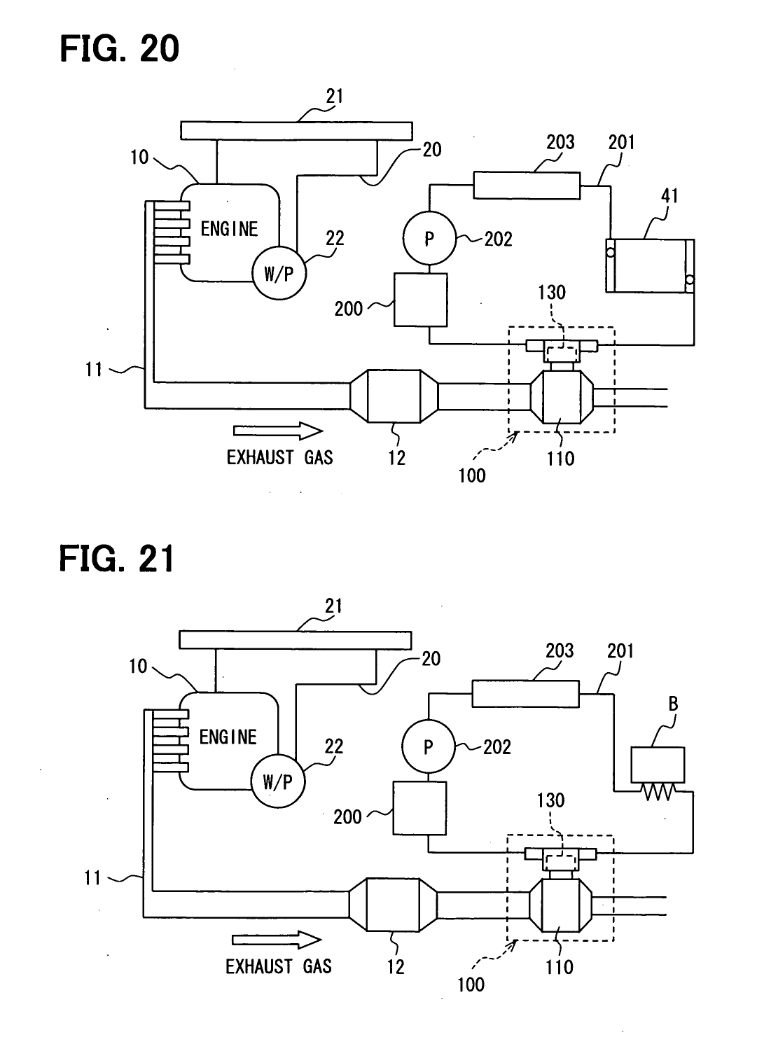

An eighth embodiment of the present invention is shown in FIG. 20. In the above embodiment, the waste heat collecting apparatus has been described, wherein the waste heat collecting apparatus 100 provided in an engine coolant circuit, and wherein the engine coolant is heated in the condensing portion 130. However, the waste heat collecting apparatus 100 may be provided such that heat exchange is carried out between (a) a heat medium (second medium) flowing in a circuit independent of or separate from the radiator circuit 20 and (b) working fluid (first medium) in the condensing portion 130. Further, the same reference numerals are used in the eighth embodiment to designate the same or similar parts and devices of the seventh embodiment, and the detailed descriptions thereof are omitted.

In FIG. 20, numeral 200 denotes an inverter for controlling rotation of a motor in a hybrid electric vehicle which runs by using either an engine or the motor. In an inverter coolant circuit 201, inverter coolant for cooling down the inverter is circulated. Further, the inverter coolant circuit 201 is provided separately from the radiator circuit 20 for cooling down the engine, and the inverter coolant serving as a heat medium (second medium) is circulated through the radiator circuit 20 by a second water pump 202. In the inverter coolant circuit 201, there is provided an inverter radiator 203 which cools down the inverter coolant by heat exchange between the inverter coolant and external air. A heater core 41 is provided upstream of the inverter radiator 203 in a flow direction of the inverter coolant.

The condensing portion 130 of the waste heat collecting apparatus 100 is provided at an upstream side of the heater core 41 of the inverter coolant circuit 201. The heat of the exhaust gas from the engine 10 is transmitted to the water (working fluid), and the water is transferred to the condensing portion 130 through the vaporizing portion 110. When the steam is condensed in the condensing portion 130, heat is emitted as condensation latent heat, and the inverter coolant flowing through the inverter coolant circuit 201 is actively heated. As a result, the temperature of the inverter coolant flowing into the heater core 41 is increased.

In particular, according to the present embodiment, the waste heat collecting apparatus 100 is provided in the independent inverter coolant circuit 201 that has a heat capacity is smaller than that of the radiator circuit 20. Therefore, as compared to the first embodiment in which the condensing portion 130 is provided in the radiator circuit 20, the temperature of the heater core 41 can be increased rapidly. Also, the waste heat collecting apparatus 100 is provided in the inverter coolant circuit 201 independent of the radiator circuit 20 for the engine 10, and the inverter coolant is circulated by the second water pump 202. Therefore, temperature of the heat core 41 is increased regardless of the operating condition of the engine 10.

Further, as a modification of the present embodiment, as shown in FIG. 21, in place of the heater core 41, a battery B for the inverter may be provided downstream of the condensing portion 130, and the battery B may be heated by the inverter coolant heated by the waste heat collecting apparatus 100.

### Ninth Embodiment

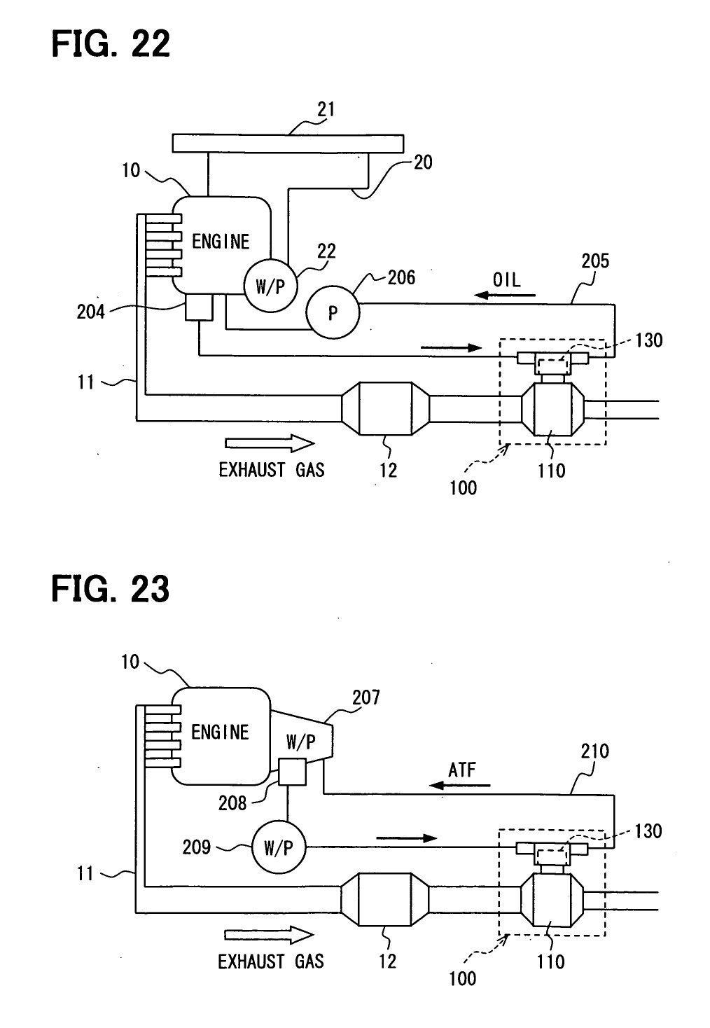

A ninth embodiment of the present invention is shown in FIG. 22. As shown in FIG. 22, even when the condensing portion 130 of the waste heat collecting apparatus 100 is provided in a circuit independent of the radiator circuit 20 and in which a heat medium different from the engine coolant flows, the same operation and effects to the embodiment described above can be obtained. Further, the same reference numerals are used in the ninth embodiment to designate the same or similar parts and devices of the eighth embodiment, and the detailed descriptions thereof are omitted.

In FIG. 22, numeral 205 denotes an oil circuit in which engine oil serving as a heat medium (second medium) is circulated by a third circulation pump 206. The oil circuit is a heat medium circuit which is independent of the radiator circuit 20. In the oil circuit 205, there is provided an oil cooler 204 that cools down the engine oil by using the engine coolant. Further, at a downstream side of the oil cooler 204 in a flow direction of the oil, there is provided the condensing portion 130 of the waste heat collecting apparatus 100.

According to the present embodiment, in the vaporizing portion 110 of the waste heat collecting apparatus 100, the heat of the exhaust gas is transmitted to water that serves as the working fluid. Further, by the condensation latent heat which is emitted when the water is condensed in the condensing portion 130, the oil flowing through the oil circuit 205 is heated. As a result, the oil heated in the condensing portion 130 can be supplied to the engine 10. Therefore, the condensing portion 130 can be used as an oil warmer, and the time required for warming the engine 10 can be shortened. Further, according to the present embodiment, the oil circuit 205 is a circuit which is independent of the radiator circuit 20 in which the engine coolant flows. Since the heat capacity of the oil circuit 205 is smaller than that of the radiator circuit 20, the temperature of the engine oil can be increased faster than the case where the condensing portion 130 of the waste heat collecting apparatus 100 is provided in the radiator circuit 20.

Further, as a modification of the present embodiment, as shown in FIG. 23, even when the condensing portion 130 of the waste heat collecting apparatus 100 is provided in an automatic transmission fluid (ATF) circuit 210, in which working oil of the automatic transmission 207 circulates, the same operation and effects to the ninth embodiment can be obtained. It should be noted that the working oil of the automatic transmission 207 is also referred as ATF and serves as a heat medium.

In FIG. 23, numeral 208 denotes an ATF warmer 208 which carries out heat exchange between the ATF and the engine coolant, and the condensing portion 130 of the waste heat collecting apparatus 100 is provided at a downstream side of the ATF warmer 208 in a flow direction of the ATF. A fourth circulation pump 209 for circulating the ATF is provided in the ATF circuit 210. By operating the fourth circulation pump 209, the ATF heated in the condensing portion 130 is allowed to flow into the automatic transmission 207. As a result, the condensing portion 130 can be used as an auxiliary ATF warmer, shortening the time required for warming the automatic transmission 207.

### Other Modifications

The valve device 150 is provided at the downstream side of the condensing portion 130 in the circulation direction of the working fluid (water) in the above embodiments. However, the valve device may be provided at an upstream side of the vaporizing portion 110.

The valve device 150 (170) is operated to open or close its passage depending on the inner pressure Pi of the working fluid of the heat pipe 101 or the temperature of the coolant. However, the valve device may be operated to open or close the passage depending on a temperature of the working fluid. To be specific, for example, a thermo-wax portion 171, which is similar to the one in the third embodiment and a valve body working in association with the thermo-wax portion 171 are used. The above thermo-wax portion 171 is provided in the condensing portion 130, so that the thermo-wax portion 171 is operated depending on the temperature of the working fluid.

The heat insulating portion 120 includes multiple air spaces defined by the heat insulating plate 121 in the above embodiments. However, the heat insulating portion 120 is not limited to the above. A heat insulating material having low heat conductivity may be disposed between the vaporizing portion 110 and the condensing portion 130, alternatively.

The return pipe 161 is arranged in the area of the exhaust gas passage in the first embodiment. However, the return pipe 161 may be arranged at such a portion outside of the exhaust gas passage (the exhaust passage in the vaporizing portion 110), so that the heat insulating wall 162 may be eliminated, preventing the effects of the exhaust gas in the return pipe 161.

So far, the embodiments using the engine coolant, inverter coolant, engine oil, ATF, etc. have been described as the heat medium. However, any heat medium (second medium) can be used as long as the similar effects are obtained.

Additional advantages and modifications will readily occur to those skilled in the art. The invention in its broader terms is therefore not limited to the specific details, representative apparatus, and illustrative examples shown and described.

What is claimed is:

1. A waste heat collecting apparatus comprising:
a loop-type heat pipe that includes:
a vaporizing portion configured to vaporize a first medium in the vaporizing portion by using heat of exhaust gas from an internal combustion engine;
a condensing portion configured to cool down the vaporized first medium, which is vaporized in the vaporizing portion, by using a second medium; and
a connecting portion configured to connect the vaporizing portion with the condensing portion; and
a valve device that includes:
a driving portion configured to be actuated in accordance with at least one of pressure of the first medium, temperature of the first medium, and temperature of the second medium; and
a valve body formed integrally with the driving portion for opening and closing the connecting portion in association with the driving portion, wherein the valve device is provided at one of (a) a position downstream of the condensing portion, and (b) a position upstream of the vaporizing portion.

2. The waste heat collecting apparatus according to claim 1, wherein:
the condensing portion is provided in a second medium passage, through which the second medium is circulated by a circulation pump; and
the second medium passage is provided independent of a radiator circuit, through which an engine coolant for cooling down the internal combustion engine circulates.

3. The waste heat collecting apparatus according to claim 1, further comprising:
a surrounding member that defines therein an exhaust gas passage, through which the exhaust gas flows, wherein:
the vaporizing portion and the connecting portion are arranged in the exhaust gas passage.

4. The waste heat collecting apparatus according to claim 1, wherein the valve body has a hysteresis in the opening and closing operation for opening and closing the connecting portion.

5. The waste heat collecting apparatus according to claim 4, wherein the hysteresis in the opening and closing operation by the valve body-is established to satisfy followings:
the valve body closes the connecting portion when the pressure sensed by the driving portion is higher than a first predetermined pressure; and
the valve body opens the connecting portion when the pressure is lower than a second predetermined pressure, which is lower than the first predetermined pressure.

6. The waste heat collecting apparatus according to claim 5, wherein:
the first medium is water;
the first predetermined pressure is 0.1 MPa; and
the second predetermined pressure is 0.05 MPa.

7. The waste heat collecting apparatus according to claim 5, wherein:
the first medium is water;
the first predetermined pressure is 0.1 MPa; and
the second predetermined pressure is 0.6 kPa.

8. The waste heat collecting apparatus according to claim 1, wherein:
the valve device has a minute aperture that enables a small amount of the first medium to flow from the condensing portion to the vaporizing portion even when the valve body closes the connecting portion.

9. The waste heat collecting apparatus according to claim 1, further comprising:
a heat insulating portion that is provided between the vaporizing portion and the condensing portion for thermally insulating the condensing portion from the vaporizing portion.

10. The waste heat collecting apparatus according to claim 9, wherein the heat insulating portion includes an air space defined by a heat insulating wall that is provided between the vaporizing portion and the condensing portion.

11. The waste heat collecting apparatus according to claim 1, further comprising:
a surrounding member that defines therein an exhaust gas passage, through which the exhaust gas flows, wherein:
the connecting portion is arranged in a position other than the exhaust gas passage.

12. The waste heat collecting apparatus according to claim 3, further comprising:
a return passage heat insulating wall that is provided at least upstream of the connecting portion in a flow direction of the exhaust gas, wherein the return passage heat insulating wall is configured to insulate against heat of the exhaust gas.

13. The waste heat collecting apparatus according to claim 1, further comprising:
a surrounding member that defines therein an exhaust gas passage, through which the exhaust gas flows, wherein:
the vaporizing portion has a plurality of passages arranged in the exhaust gas passage, each of the plurality of passages having a longitudinal axis extending in a vertical direction;
the condensing portion is arranged at a position higher than the vaporizing portion in the vertical direction, the condensing portion being arranged in a second medium passage, through which the second medium flows; and
the connecting portion is a return passage that has a longitudinal length generally equal to that of each of the plurality of passages.

14. The waste heat collecting apparatus according to claim 13, wherein the connecting portion is arranged downstream of the plurality of passages in a flow direction of the exhaust gas.

15. The waste heat collecting apparatus according to claim 1, wherein:
the vaporizing portion includes:
a plurality of passages arranged in the exhaust gas passage, each of the plurality of passages having a longitudinal axis extending in a vertical direction;
a first header portion configured to collect the vaporized first medium vaporized in the plurality of passages; and
a second header portion configured to distribute the condensed first medium into the plurality of passages, the first medium being condensed in the condensing portion;
the condensing portion is arranged in a second medium passage, through which the second medium flows; and
the condensing portion is communicated with the first header portion and with the second header portion via the connecting portion.

16. The waste heat collecting apparatus according to claim 1, wherein:
the driving portion of the valve device includes a diaphragm that is displaced to move the valve body depending on the pressure of the first medium.

17. The waste heat collecting apparatus according to claim 1, wherein:
the driving portion of the valve device includes a thermo-wax portion that has wax filled therein; and
the thermo-wax portion is expanded and contracted depending on one of the temperature of the first medium and the temperature of the second medium.

18. The waste heat collecting apparatus according to claim 17, wherein:
the thermo-wax portion is expanded or contracted depending on the temperature of the second medium;
the valve body includes a pleated flexible bellows that has an open end and a closed end, the open end of the bellows receiving a part of the thermo-wax portion;
the bellows is expanded and contracted by the thermo-wax portion; and
the valve device includes a communication port so that the second medium flows into the bellows.

19. The waste heat collecting apparatus according to claim 15, wherein:
the connecting portion has an entry passage, which allows the first medium vaporized in the vaporizing portion to flow into the condensing portion, and a return passage, which allows the first medium cooled down in the condensing portion to be returned to the vaporizing portion;
the entry passage and the return passage are arranged adjacent to each other; and
the entry passage is arranged at a position higher in the vertical direction than a liquid level of the first medium in the vaporizing portion, the liquid level being set when the heat collecting apparatus is not operated.

20. The waste heat collecting apparatus according to claim 1, wherein the connecting portion is formed by a single passage, which is arranged at a position higher in a vertical direction than a liquid level of the first medium in the vaporizing portion, the liquid level being set when the heat collecting apparatus is not operated.

21. The waste heat collecting apparatus according to claim 20, further comprising:
a partitioning wall that is provided in the pipe, the partitioning wall limiting the first medium vaporized in the vaporizing portion from contacting the first medium cooled down in the condensing portion.

22. The waste heat collecting apparatus according to claim 1, wherein:
the valve device is arranged at a position higher in a vertical direction than a liquid level of the first medium in the vaporizing portion, the liquid level being set when the heat collecting apparatus is not operated.

23. The waste heat collecting apparatus according to claim 1, wherein the condensing portion includes:
a first medium passage, through which the first medium flows; and
reverse flow limiting means that is provided to the first medium passage of the condensing portion for limiting the first medium, which has been cooled down, from returning to the vaporizing portion.

24. The waste heat collecting apparatus according to claim 23, wherein:
the reverse flow limiting means is a plate member, which projects from an inside of the first medium passage to be angled relative to a flow direction of the first medium.

25. The waste heat collecting apparatus according to claim 23, wherein:
the reverse flow limiting means is a restricting portion that reduces an inner diameter of a part of the first medium passage.
